(19) United States
(12) Patent Application Publication
(10) Pub. No.: US 2010/0012649 A1
(43) Pub. Date: Jan. 21, 2010

(54) IRRADIATION FACILITY OF RADIANT HEAT

(76) Inventor: Kuk Rae Cho, Kyungnam (KR)

Correspondence Address: MARTINE PENILLA & GENCARELLA, LLP, 710 LAKEWAY DRIVE, SUITE 200, SUNNYVALE, CA, 94085, US

(21) Appl. No.: 12/504,205

(22) Filed: Jul. 16, 2009

Related U.S. Application Data
(63) Continuation of application No. PCT/KR2008/000311, filed on Jan. 18, 2007.

(30) Foreign Application Priority Data
Jan. 18, 2007 (KR) 10-2007-0005656

(51) Int. Cl. H05B 6/70

(52) U.S. Cl. 219/690

(57) ABSTRACT

A irradiation facility of radiant heat comprises one or more radiation generators (10); and a waveguide (20) connecting between the radiation generator (10) and a target object (30) to increase irradiation distance thereof such that electromagnetic waves in a radiation region provided from at least one of the radiation generators (10) are irradiated onto the target object (30). The irradiation facility of radiant heat is characterized of a substantially increased radiation distance of electromagnetic wave in a radiation region and unlimited yet variable radiation direction and radiation intensity to be able to focus the radiation only on the target object, so that energy efficiency and product quality of the target object are improved while power consumption is reduced.

### CLAIM OF PRIORITY

This application claims priority under 35 U.S.C. §§ 120 and 365(c) as a continuation application of prior International Application PCT/KR2008/000311, which was filed on Jan. 18, 2007, and which was published in English under PCT Article 21(2). The disclosure of the prior international application is incorporated herein by reference.

### TECHNICAL FIELD

The present invention relates to a irradiation facility of radiant heat capable of heating a target object or improving drying efficiency by inducing a radiant heat; and, more particularly, to a irradiation facility of radiant heat which can provide a substantially increased radiation distance of electromagnetic wave in a radiation region and can focus the radiation only on the target object with unlimited yet adjustable radiation direction and radiation intensity, such that improvements in energy efficiency and product quality of the target object and reduction in power consumption may be attained.

### BACKGROUND ART

Traditional heating devices or drying machines using radiation are designed to irradiate radiant heat directly on a target object or through a reflector.

However, such devices using radiation typically have a relatively short irradiation distance of 70 cm (far-infrared region) to 1 m (near infrared region), so they could not heat or dry a large structure or construction very effectively. It was another disadvantage of those devices that irradiation direction and irradiation intensity could not be varied. Besides, in a certain structure the radiation loss through walls, windows, doors, tools, etc., was great.

### DISCLOSURE

### Technical Problem

To overcome deficiencies of the related art, it is, therefore, an object of the present invention to provide a irradiation facility of radiant heat which can provide a substantially increased radiation distance of electromagnetic wave in a radiation region and can focus the radiation only on the target object with unlimited yet adjustable radiation direction and radiation intensity, such that improvements in energy efficiency and product quality of the target object and reduction in power consumption may be attained.

### Technical Solution

In accordance with an aspect of the present invention, there is provided an a irradiation facility of radiant heat which includes: one or more radiation generators; and a waveguide connecting between the radiation generator and a target object to increase irradiation distance thereof such that electromagnetic waves in a radiation region provided from at least one of the irradiation generators are irradiated onto the target object.

The waveguide according to an exemplary embodiment of the present invention is a device to induce electromagnetic wages in a radiation region provided from the radiation generator at a far distance, and any of conventional waveguides can be utilized. The waveguide is made out of a metal having high efficiency of electromagnetic wave reflection. Preferable examples of such material include silver, copper, aluminum, stainless steel, and plated products thereof.

To extend irradiation distance, the waveguide is composed of straight conduits having a fixed diameter or a gradually increasing diameter, and curved conduits bent to a predetermined direction, each conduit having a circular or rectangular sectional shape. Such a straight conduit and a curved conduit are implemented as a means for increasing the irradiation distance.

Such a waveguide may include a concentrating conduit to concentrate a radiant heat provided by a radiation generator and reflected from a reflector, and a branch conduit to split the radiant heat. Such a concentrating conduit and a branch conduit function as a means for varying the irradiation direction and the irradiation intensity. Moreover, an electromagnetic horn installed at the end of the waveguide can expand the irradiation direction even more.

Additionally, the irradiator of the present invention may further include a ventilation waveguide, an adhesive waveguide/pleated curtain type waveguide, a flat diffuse reflective waveguide, a bottom waveguide, etc. Here, the adhesive waveguide indicate any kind of a thin waveguide coated with an adhesive layer to be applied to the inner wall face or the ceiling of a drying machine for example.

### Advantageous Effects

With the use of a waveguide for heating or drying with a radiant heat, a short irradiation distance can be increased up to several tens of meters and therefore, large scale of structure can treated, high capacity and high efficiency work can be accomplished. In addition, the irradiation facility of radiant heat of the present invention can reduce power consumption substantially and achieve major improvements in energy efficiency and heating or drying effects on a target object.

### BRIEF DESCRIPTION OF THE DRAWINGS

FIG. 1 is a conceptual view of a first embodiment using a irradiation facility of radiant heat according to the present invention.

FIG. 2 is a conceptual view of a second embodiment using a irradiation facility of radiant heat according to the present invention.

FIG. 3 is a conceptual view of a third embodiment using a irradiation facility of radiant heat according to the present invention.

FIG. 4 is a conceptual view of a fourth embodiment using a irradiation facility of radiant heat according to the present invention.

FIG. 5 is a conceptual view of a fifth embodiment using a irradiation facility of radiant heat according to the present invention.

FIG. 6 is a conceptual view of a sixth embodiment using a irradiation facility of radiant heat according to the present invention.

### BEST MODE FOR THE INVENTION

The advantages, features and aspects of the invention will become apparent from the following description of the embodiments with reference to the accompanying drawings, which is set forth hereinafter.

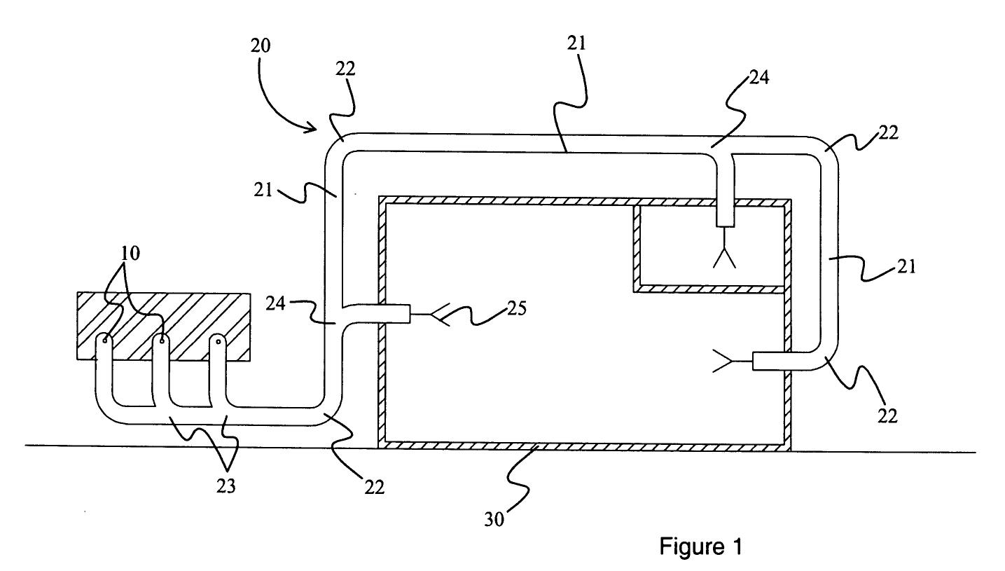

FIG. 1 is a conceptual view of a first embodiment using a irradiation facility of radiant heat according to the present invention. A irradiation facility of radiant heat includes one or more radiation generator 10, and a waveguide 20 connecting between the radiation generator 10 and a target object 30 to increase irradiation distance thereof such that electromagnetic waves in a radiation region provided from at least one of the irradiation facility of radiant heats 10 are irradiated onto the target object 30. Here, the target object 30 may be a block of a ship that needs to be dried after a painting process, or a plurality of compartment structures that require heating.

A reflector or an electromagnetic horn (not shown in detail) is installed around the radiation generator 10, so that a radiant heat may not be spread over any directions but led towards the waveguide 20. It is also possible to surround the radiation generator 10 with an insulating material to improve safety and thermal efficiency.

Preferably, the radiation generator 10 stands in a vertical form.

The waveguide 20 according to an exemplary embodiment of the present invention is a device to induce electromagnetic wages in a radiation region provided from the radiation generator 10 at a far distance, and any of conventional waveguides can be utilized. The waveguide is made out of a metal having high efficiency of electromagnetic wave reflection. Preferable examples of such material include silver, copper, aluminum, stainless steel, and plated products thereof.

The waveguides 20 may be constituted by a plurality of straight conduits 21 having a fixed diameter or a gradually increasing diameter to extend irradiation distance, and a plurality of curved conduits 22 bent to a predetermined direction, each conduit having a circular or rectangular sectional shape. Such a straight conduit 21 and a curved conduit 22 are implemented as a means for increasing the irradiation distance.

In addition, the waveguide 20 may be formed into a concentrating conduit 23 to concentrate a radiant heat generated by the radiation generator 10 and reflected from the reflector, and a branch conduit 24 to split the radiant heat. Such a concentrating conduit 23 and a branch conduit 24 function as a means for varying the irradiation direction and the irradiation intensity.

For instance, as shown in FIG. 1, a radiant heat generated by the radiation generator 10 turns in the right direction through the concentrating conduit 23, goes upward by the curved conduit 22, is split by the branch conduit 24, and is finally led into the target object 30. The irradiation intensity of the radiant heat especially at an upstream branch conduit 24 and at a downstream branch conduit 24 can be varied or fixed uniformly by controlling the sectional area of the branch conduit 24.

Further, an electromagnetic horn 25 may be installed at the end of the waveguide 20 built in the target object 30, so as to expand the irradiation direction of radiation even more.

The thusly constructed irradiation facility of radiant heat can irradiate radiation to a comparatively much longer distance than the related art by causing electromagnetic waves in a radiation region provided from at least one of the radiation generator 10 to travel through the waveguide 20, that is, the concentrating conduit 23, the plural straight conduits 21, the plural curved conduits 22, and the branch conduit, to the target object 30.

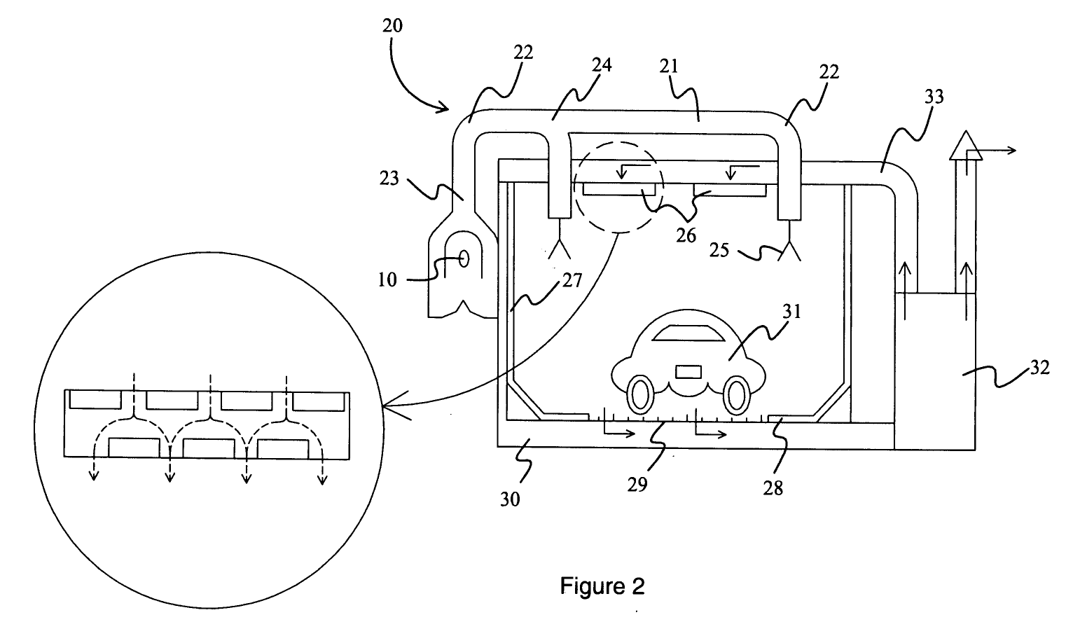

FIG. 2 is a conceptual view of a second embodiment using a irradiation facility of radiant heat according to the present invention. A irradiation facility of radiant heat of this embodiment includes one or more radiation generator 10, and a waveguide 20 connecting between the radiation generator 10 and a target object 30 to increase irradiation distance thereof such that electromagnetic waves in a radiation region provided from at least one of the radiation generator 10 are irradiated onto the target object 30. Here, the target object 30 may be a drying chamber for example that has a certain product 31 to be dried. FIG. 2 is provided assuming an automobile as the product 31.

The irradiation facility of radiant heat of the second embodiment differs from the first embodiment by including a ventilation waveguide 26, an adhesive waveguide 27, a bottom waveguide 28, and an air circulation system. Other components similar to those in the first embodiment are denoted by the same reference numerals and will not be explained here.

The ventilation waveguide 26 has a zigzag channel (see an enlarged view in FIG. 2 where a dotted line indicates air flow passage) therein. Therefore, air having entered a target object 30 from a fan/filter 32 (to be described) through an air pipe 33 comes in and out freely, but an electromagnetic wave in the radiation region having entered the target object 30 through a branch conduit 24, by its nature, cannot escape the ventilation waveguide 26.

The adhesive waveguide 27 is a thin waveguide coated with an adhesive layer to be applied to the walls or the ceiling of the target object 30 such as a drying chamber. This adhesive waveguide 27 is applied to the front, rear and both sides of the drying chamber or at least one of them to create a heat-retaining space, so that the radiation may be irradiated to the far distance and thermal efficiency of the drying chamber itself is substantially improved. Meanwhile, if the walls are made out of a certain material or formed in a certain structure or pattern that make it difficult for the adhesive layer of the adhesive waveguide 27 to be applied easily, a pleated curtain type waveguide (not shown) with an open-up bottom and a narrowed top may be employed as well.

The bottom waveguide 28 is installed to surround the bottom surface of the target object 30 (i.e. the drying chamber) except for a ventilation grid 29.

In case that a person works inside the irradiation facility of radiant heat, the waveguide is preferably made of a flat diffuse reflective material to protect eyesight of the worker.

The air circulation system is constituted by a fan/filter 32 arranged around the target object 30, and an air pipe 33 connecting between the fan/filter 32 and the target object 30. FIG. 2 shows an air flow indicated by an arrow.

The thusly constructed irradiation facility of radiant heat can irradiate radiation to a long distance by causing electromagnetic waves in a radiation region provided from at least one of the radiation generator 10 to travel through the waveguide 20, that is, the concentrating conduit 23, the plural straight conduits 21, the plural curved conduits 22, and the branch conduit, to the target object 30. In addition, the electromagnetic wave in the radiation region is either absorbed on the walls by the ventilation waveguide 26, the adhesive waveguide 27 or the pleated curtain type waveguide, and the bottom waveguide 28, or retained through the air circulation system, such that the thermal efficiency of the irradiator is increased markedly.

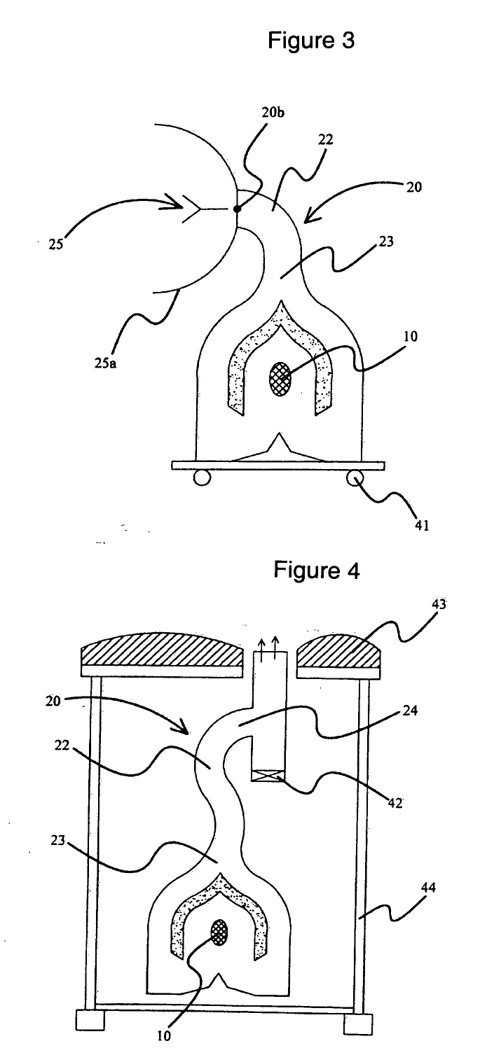

FIG. 3 is a conceptual view of a third embodiment using a irradiation facility of radiant heat according to the present invention. A irradiation facility of radiant heat of this embodiment also includes one or more radiation generator 10, and a waveguide 20 to increase irradiation distance thereof such that electromagnetic waves in a radiation region provided from at least one of the irradiation facility of radiant heats 10 are irradiated onto the target object 30 through an opening 20b. Here, the radiation generator may have a structure similar to that of an electric heater, and in this case air or a person around it becomes a target object.

The irradiation facility of radiant heat of the third embodiment differs from the first and second embodiments by including a reflector 25a at the end of the opening 20b and a plurality of moving wheels 41. Other components similar to those in the first embodiment are denoted by the same reference numerals and will be explained briefly here.

The irradiation facility of radiant heat is provided with a concentrating conduit 23 to concentrate a radiant heat from the radiation generator 10, a curved conduit 22 to change the irradiation direction of the radiant heat, and an electromagnetic horn 25 and a reflector 25a arranged at the end of the waveguide 20 to expand or disperse the irradiation of radiation even further. This structure enables the radiation with thermal effects to be emitted towards the target object.

FIG. 4 is a conceptual view of a fourth embodiment using a irradiation facility of radiant heat according to the present invention. A irradiation facility of radiant heat of this embodiment also includes one or more radiation generator 10, and a waveguide 20 to increase irradiation distance thereof such that electromagnetic waves in a radiation region provided from at least one of the radiation generators 10 are irradiated onto a target object (not shown). Here, the irradiation facility of radiant heat may have a structure similar to that of a sitz bath, and in this case a person sitting therein becomes a target object.

The irradiation facility of radiant heat of the fourth embodiment differs from the first through third embodiments by including a housing 44 to encompass the radiation generator 10 and the waveguide 20, a saddle 43 mounted at the top of the housing 44, and an impurity exhaust conduit 42 to remove impurities. Other components similar to those in the first embodiment are denoted by the same reference numerals and will be explained briefly here.

As to the structure of the irradiation facility of radiant heat of the fourth embodiment, a concentration conduit 23 concentrates a radiant heat provided by the radiation generator 10 and reflected from a reflector, a curved conduit 22 and a branch conduit 24 vary the irradiation direction of radiation, and the impurity exhaust conduit 42 not only exhausts impurities but also emits the radiant heat between the saddles 43.

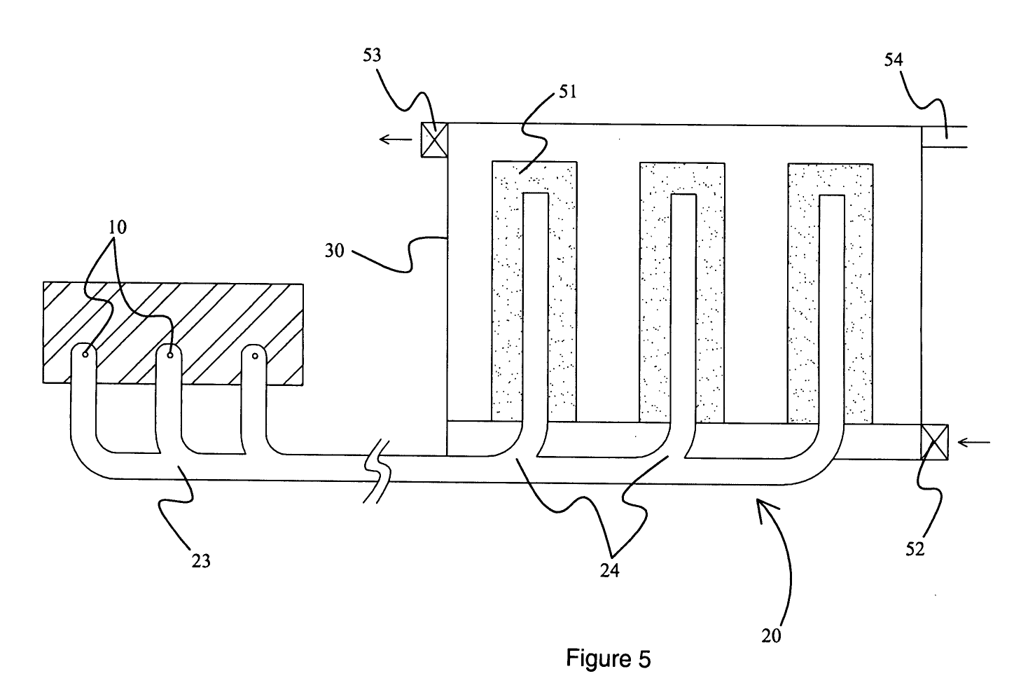

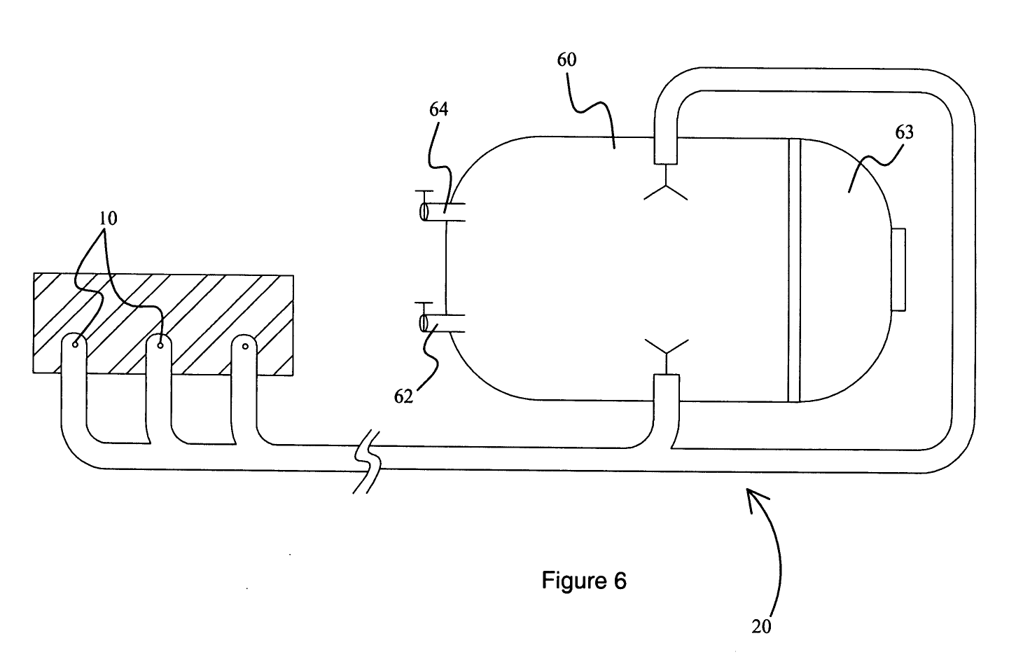

FIG. 5 is a conceptual view of a fifth embodiment using a irradiation facility of radiant heat according to the present invention. A irradiation facility of radiant heat of this embodiment also includes one or more radiation generator 10, and a waveguide 20 to increase irradiation distance thereof such that electromagnetic waves in a radiation region provided from at least one of the irradiation facility of radiant heats 10 are irradiated onto a target object 30. Here, the irradiation facility of radiant heat may have a structure similar to that of a vacuum discharge device to enable the target object 30 to purify contaminated air through an activated carbon filter 51 and get rid of impurities by means of absorption.

The irradiation facility of radiant heat of the fifth embodiment differs from the first through fourth embodiments by including a cartridge type activated carbon filter 51 built in the target object 30, an inlet valve 52 to invite contaminated air, a conduit 54 connected to a separate vacuum pump (not shown), and an exhaust valve 53 to exhaust clean air. Other components similar to those in the first embodiment are denoted by the same reference numerals and will be explained briefly here.

As to the structure of the irradiation facility of radiant heat of the fifth embodiment, a concentration conduit 23 concentrates a radiant heat provided by the radiation generator 10 and reflected from a reflector, a plurality of branch conduits 24 split the radiant heat, and a straight conduit or a curved conduit (this is provided optionally as needed) allows the radiant heat to be transferred to the activated carbon filter 51 so that the activated carbon filter may reach a discharge temperature in vacuo. This structure can considerably reduce the risk of fire compared to any of conventional activated carbon discharge devices.

FIG. 6 is a conceptual view of a sixth embodiment using a irradiation facility of radiant heat according to the present invention. Unlike the other embodiments shown in FIG. 1 through FIG. 5, the irradiation facility of radiant heat of the sixth embodiment can be applied to a product requiring the vacuum freezing treatment.

As shown in FIG. 6, the irradiation facility of radiant heat of the sixth embodiment includes one or more radiation generator 10, and a waveguide 20 with an extended length to increase irradiation distance thereof such that electromagnetic waves in a radiation region provided from at least one of the radiation generators 10 are irradiated onto a vacuum freeze dryer 60. In particular, the vacuum freeze dryer 60 is designed to expose a frozen product directly to a radiant heat such that the product begins to sublimate, or change to vapor, and dry out, without going through a liquid phase. To this end, the vacuum freeze dryer 60 of the irradiation facility of radiant heat includes a cold wind/refrigerant conduit 62, a conduit 64 connected to a separate vacuum pump (not shown), a waveguide 20 to guide a radiant heat concentrated at the radiation generator 10 into the vacuum freeze dryer, and a hatch 63 through which a target product to be dried is taken in or out.

As just mentioned above, the vacuum freeze dryer 60 is built in a manner that one can put/withdraw a product into/from it through the hatch 63, and if additional refrigeration is required it opens the cold wind/refrigerant conduit 62 to introduce cold air into the vacuum freeze dryer and freeze the product. Especially, the vacuum freeze dryer 60 activates the vacuum pump to keep its interior in vacuum state and emits the radiant heat therein by means of the waveguide 20. In this way, the frozen product is sublimed, and the sublimed gas is exhausted to the conduit 64.

Further, the inner face of the vacuum freeze dryer 60 is made of a waveguide material. This facilitates diffusion of electromagnetic waves in the radiation region into the vacuum freeze dryer.

What is claimed is:

1. A irradiation facility of radiant heat, comprising:
one or more radiation generators (10); and
a waveguide (20) connecting between the radiation generator (10) and a target object (30) to increase irradiation distance thereof such that electromagnetic waves in a radiation region provided from at least one of the radiation generators (10) are irradiated onto the target object (30).

2. The irradiation facility of radiant heat according to claim 1, wherein the waveguide (20) comprises a plurality of straight conduits (21) having a fixed diameter or a gradually increasing diameter and a plurality of curved conduits (22) bent, to extend irradiation distance of a radiant heat.

3. The irradiation facility of radiant heat according to claim 1, wherein the waveguide (20) comprises a concentrating conduit (23) to concentrate a radiant heat, a branch conduit (24) to split the radiant heat, and an electromagnetic horn (25), so as to vary irradiation direction and irradiation intensity of the radiant heat.

4. The irradiation facility of radiant heat according to one of claim 1 through claim 3, wherein the target object (30) further comprises a ventilation waveguide (26) having a zigzag shape channel, and an adhesive waveguide (27) having an adhesive layer to be applied to a wall face or a pleated curtain type waveguide attached on a wall face in a vertical direction, so as to prevent radiation loss.

5. The irradiation facility of radiant heat according to claim 4, further comprising:
a waveguide made out of a flat diffuse reflective material.

6. A irradiation facility of radiant heat in form of a heater, comprising:
one or more radiation generators (10);
a waveguide (20) connecting between the radiation generator (10) and an opening (20b) to increase irradiation distance thereof such that electromagnetic waves in a radiation region provided from at least one of the radiation generators (10) are irradiated through the opening (20b); and
a reflector (25a) installed at an end of the opening (20b).

7. A irradiation facility of radiant heat in form of a sitz bath capable of exhausting impurities and emitting radiation, the irradiation facility of radiant heat comprising:
one or more radiation generators (10);
a waveguide (20) connecting between the radiation generator (10) and a target object to increase irradiation distance thereof such that electromagnetic waves in a radiation region provided from at least one of the radiation generators (10) are irradiated onto the target object;
a housing (44) to encompass the components;
a saddle (43) mounted at the top of the housing (44); and
an impurity exhaust conduit (42) to remove impurities

8. A irradiation facility of radiant heat in form of a vacuum discharge device, comprising:
one or more radiation generators (10);
a waveguide (20) connecting between the radiation generator (10) and a target object (30) to increase irradiation distance thereof such that electromagnetic waves in a radiation region provided from at least one of the radiation generators (10) are irradiated onto the target object (30);
a plurality of activated carbon filters (51) built in the target object (30);
an inlet valve (52) to invite contaminated air into the target object (30);
a conduit (54) connected to a separate vacuum pump; and
an exhaust valve (53) to exhaust clean air from the target object (30).

9. A irradiation facility of radiant heat in form of a vacuum freeze dryer capable of transferring a radiant heat to a frozen product to dry the same via a sublimation process, the irradiation facility of radiant heat comprising:
one or more radiation generator (10); and
a waveguide (20) with an extended length to increase irradiation distance thereof such that electromagnetic waves in a radiation region provided from at least one of the radiation generators (10) are irradiated onto a vacuum freeze dryer (60), wherein the vacuum freeze dryer (60) includes a cold wind/refrigerant conduit (62) to supply cold air or a refrigerant, a hatch (63) through which a target product to be dried is taken in or out, and a conduit (64) connected to a separate vacuum pump.

10. The irradiation facility of radiant heat according to claim 9, wherein an inner face of the vacuum freeze dryer (60) is made of a waveguide material.

11. The irradiation facility of radiant heat according to one of claim 1 or claims 6 through 9, wherein the radiation generator (10) is installed vertically.
